(19) United States
(12) Patent Application Publication
(10) Pub. No.: US 2012/0175128 A1
(43) Pub. Date: Jul. 12, 2012

(54) METHOD AND APPARATUS FOR DISSIMILAR METAL COMPLETION SYSTEM

(76) Inventor: Dominic Brady, Winchester (GB)

(21) Appl. No.: 13/314,491

(22) Filed: Dec. 8, 2011

Related U.S. Application Data
(60) Provisional application No. 61/430,813, filed on Jan. 7, 2011.

(51) Int. Cl. E21B 43/00; F16B 1/00; B23K 31/02

(52) U.S. Cl. 166/378; 228/101; 403/179

(57) ABSTRACT

Methods and apparatus for use in a well. A first component made of a first material and a second component made of a second material are provided. The first and second materials are dissimilar to each other. An adaptor is also provided, where part of the adaptor is made of or compatible with the first material, and another part of the adaptor is made of or compatible with the second material. The first component is connected to the adaptor, as is the second component. The combined adaptor and first and second components are deployed into a downhole well system.

### CROSS REFERENCE TO RELATED APPLICATION

This application claims the benefit of a related U.S. Provisional Application Ser. No. 61/430,813 filed Jan. 7, 2011, entitled “Dissimilar Material Adaptor Using Explosion Welding,” to Dominic Brady, the disclosure of which is incorporated by reference herein in its entirety.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir. These well completion components may be constructed from various materials, as determined by the environmental conditions they will likely encounter when employed downhole. Often the well completion components are interconnected to allow communication and transfer of fluids between the components and between the reservoir and the surface.

### SUMMARY

In an embodiment, a completion system includes a first component and a second component. Each component is made at least partly of a different, dissimilar material. An adaptor connects the first and second components, through a non-mechanical type connection. The part of the adaptor that connects to the first component is made of or compatible with the material of the first component, and the part of the adaptor that connects to the second component is made of or compatible with the same material of the second component. In an embodiment, a technique for providing a connection between two downhole completion components includes providing a first and a second component, each made at least partly of a different and dissimilar material. An adaptor is provided, where parts of the adaptor are made of the different and dissimilar materials, or materials which are compatible with the different and dissimilar materials, and the parts of the adapter are joined together through a bond formed through an explosive bonding process. The first and second components are joined to the adaptor, and the combination of the adaptor and first and second components is deployed into a downhole well environment.

### BRIEF DESCRIPTION OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of this disclosure; and

FIG. 1 is a schematic illustration of an example of a well system comprising a sensor, according to an embodiment of the disclosure;

FIG. 2 is a schematic illustration of an example of a downhole completion system component, according to an embodiment of the disclosure;

FIG. 3 is a schematic illustration of an example of a buoyant downhole sensor, according to an embodiment of the disclosure; and

FIG. 4 is a schematic illustration of an example of a joined connection between a first completion system component, an adaptor, and a second completion system component, according to an embodiment of the disclosure.

### DETAILED DESCRIPTION

In the following description, numerous details are set forth to provide an understanding of the present disclosure. However, it will be understood by those skilled in the art that the embodiments of the present disclosure may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments. However, when applied to equipment and methods for use in environments that are deviated or horizontal, such terms may refer to a left to right, right to left, or other relationship as appropriate.

Embodiments of this disclosure generally relate to systems and methods for deploying downhole components into a well system. In some circumstances, the components are deployed into downhole conditions which may require at least part of the components to be constructed from materials which are dissimilar to each other. For instance, one component may be exposed to a hazardous or corrosive environment or substance, while another component in the well system may not be so exposed. Exposure to the hazardous or corrosive environment or substance may contribute to a material selection for at least part of the exposed component that is different from the material selected for the non-exposed component(s). In some circumstances, these material selections may result in components being made of metals which are dissimilar to each other. One characteristic of metals which are dissimilar to each other is that they cannot be easily joined together through conventional welding processes like MIG, TIG, electron beam, or friction welding. Joining components made of dissimilar materials may require suitable mechanical joints (usually resulting in a pressure barrier) which may be expensive, of significant size and complexity and which may result in mechanical areas that are deleterious for downhole survivability, e.g. for resistance to crevice corrosion. As a non-limiting example, titanium and titanium alloys are dissimilar from stainless steels, stainless steel alloys, inconel, inconel alloys, monel, and monel alloys. In contrast to dissimilar materials, are materials which are the same, or compatible with each other. Materials which are the same may be joined together through conventional welding processes like MIG, TIG, electron beam or friction welding. Likewise, compatible materials, while not the same, may also be joined typically be joined together through welding processes like MIG, TIG, electron beam or friction welding. One non-limiting example of compatible materials are inconel and stainless steel, which may be joined together through welding. Another non-limiting example of compatible materials is titanium 6246 and a grade 2 type titanium, which may also be joined together through welding.

In an embodiment, a completion system for deployment in a well system includes a first component and a second component. Each component is made at least partly of a different, dissimilar material. An adaptor connects the first and second components, through a non-mechanical type connection. The part of the adaptor that connects to the first component is made of material compatible to or the same as the first component at its connection point, and the part of the adaptor that connects to the second component is made of material compatible to or the same as the second component at its connection point. In an embodiment, a technique for providing a connection between two downhole completion components includes providing a first and a second component, each made at least partly of different and dissimilar materials. An adaptor is provided, where parts of the adaptor are made of the different and dissimilar materials, or materials which are compatible with the different and dissimilar materials, and the parts of the adapter are joined together through a bond formed through an explosive bonding process. The first and second components are joined to the adaptor, and the combination of the adaptor and first and second components is deployed into a downhole well environment.

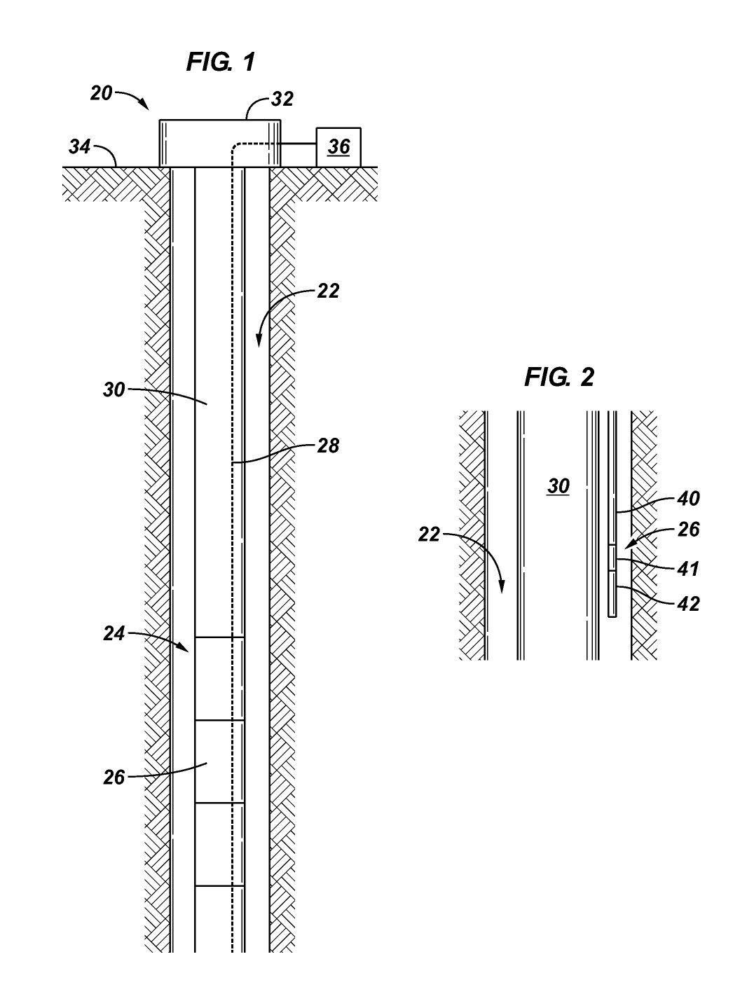

Referring generally to FIG. 1, an example of a well system 20 is illustrated as deployed in a wellbore 22, according to one embodiment of the present disclosure. The well system 20 comprises downhole equipment 24 that may be in the form of a downhole completion or other equipment. As illustrated, downhole equipment 24 comprises one or more downhole completion system components 26 that may be actuated or communicated with along a communication pathway 28 to the surface. The communication pathway 28 to the surface may be routed at least in part along a pathway on the interior of a control line which is suitable for an electrical conductor, a fiber optic, or hydraulic/pneumatic fluid to be disposed within. In some embodiments, actuation of, or communication to the downhole completion system components 26 may be achieved by communication along an electrical conductor, a fiber optic or fluid flow path disposed within a control line along communication pathway 28. In some embodiments, the downhole completion system component 26 illustrated in FIG. 1 may comprise, for example, a downhole control valve, a sensor, a sensor gauge assembly, or a packer. However, other types of downhole tools or devices may also be actuated or communicated with via the communication pathway 28.

The configuration of well system 20 may vary substantially depending on the specific well application for which it is designed. Accordingly, the embodiment illustrated is simply an example to facilitate explanation of the present technique for deploying downhole components in a well. In the example illustrated in FIG. 1, downhole equipment 24 is deployed into the wellbore 22 via a conveyance 30, such as production tubing, coiled tubing, cable, or other suitable conveyance. The wellbore extends downwardly from a well head 32 positioned at a surface location 34 (which may either be terrestrial or subsea). Additionally, a communication system 36 may be used to communicate with the completion system component 26 along communication pathway 28. In some embodiments the communication system 36 may be an actuating fluid supply system, used to deliver pressurized fluid along the communication pathway 28 to the completion system component 26. However, pressurized actuating fluid may be supplied from other systems or from the natural pressure within the wellbore 22 at depth. In other embodiments, the communication system 36 may be a fiber optic interrogation system, used to deliver and receive light signals, through a fiber optic deployed along communication pathway 28, so as to communicate with completion system component 26. In other embodiments, communication system 36 may be an electrical communication system, used to deliver and receive electrical signals, through an electrical conductor (e.g. a wire) deployed along communication pathway 28, so as to communicate with the completion system component 26. Furthermore, well system 20 may be employed in wellbores 22 that are generally vertical and/or in wellbores that are deviated e.g. horizontal.

Referring generally to FIG. 2, one embodiment of downhole completion system component 26 is illustrated. In this embodiment, the downhole completion system component 26 is illustrated as comprising a first completion system component 40, a second completion system component 42, and an adaptor 41. As illustrated, the completion system component 26 assembly may be disposed at nearly any point in the wellbore 22. While shown in FIG. 2 as being disposed outside of the conveyance 30, in some embodiments the completion system component 26 assembly may also be disposed within the conveyance 30. In some embodiments, the first completion system component 40 may be a control line, and the second completion system component 42 may be a sensor or a sensor assembly.

When the first completion system component 40 comprises a control line, it may be made of a material such as inconel, inconel alloy, stainless steel, or a stainless steel alloy. Examples of these materials include, but are not limited to inconel 625, inconel 825, inconel 718, or stainless steels 304, 316, 316L.

Typically, control lines are metal tubes, which allow through their interior some sort of control signal to be sent or run. Typical control signal media include electrical conductors (e.g. wires), fiber optics, or fluid pressure signals. These control media are typically run or sent on the interior of the control line so as to separate the control media from the surrounding conditions of the wellbore 22, which may include increased pressure, temperature, or hazardous and corrosive environments. Control lines such as these described may provide on their interior a communication pathway 28 as described previous with reference to FIG. 1.

When the second completion system component 42 comprises a sensor or a sensor assembly, it may be a made at least in part from titanium or a titanium alloy. Examples of these materials include, but are not limited to grade 2 titanium, grade 12 titanium, grade 28 titanium, or any other titanium compliant with NACE MR0175. In some embodiments, the second completion system may comprise a mounting point which lacks a physical crevice for enhanced corrosion resistance or an actuator or any system where it is advantageous to exploit the materials properties of multiple alloys for different specific purposes, such as: the corrosion resistance, erosion resistance thermal expansion coefficient, thermal conductivity, strength, modulus or ultimately where the cost of using one material throughout the system is prohibitive or would be onerous to engineer.

Typically, sensor or sensor assemblies will be attached to control lines so that the control signal media disposed within a control line may interface with the sensor or sensor assembly, and allow communication to/from the sensor and the surface. Sensor assemblies may obtain information on various downhole conditions, including without limitation, pressure, temperature, fluid flow rates, and fluid composition. A given sensors or sensor assembly may also obtain information on more than one downhole condition and/or at more than one downhole location.

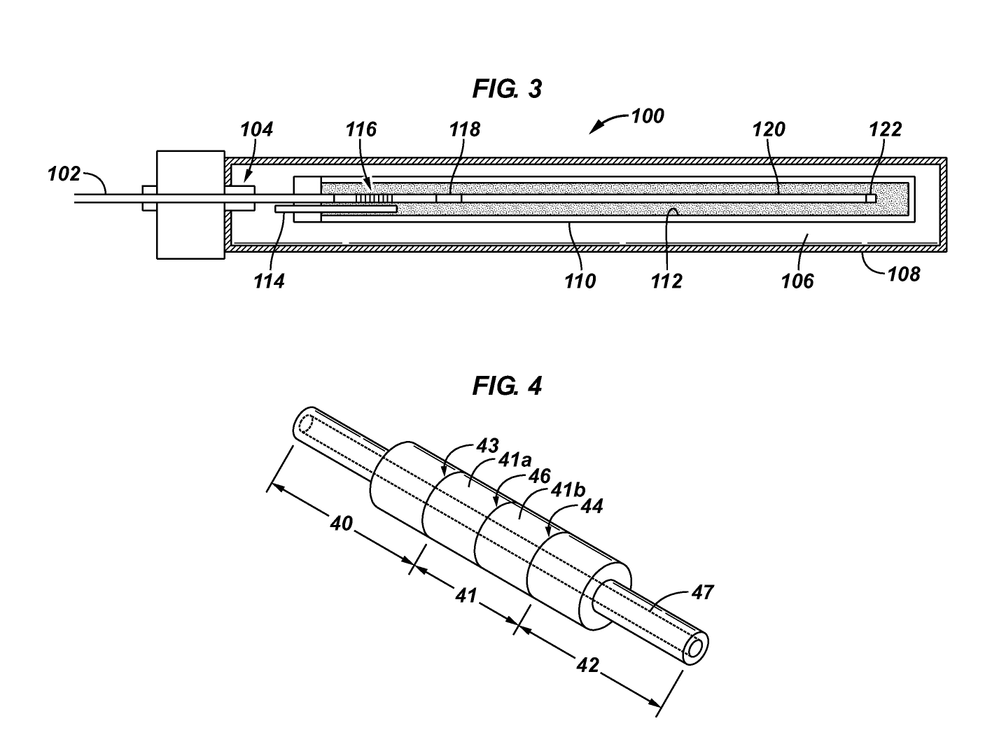

An example of a combined temperature and pressure sensor unit 100 which may be employed in various embodiments where a second completion system component 42 is a sensor or sensor assembly, is shown in the schematic cross-sectional view of FIG. 3. The sensor unit 100 includes an optical fiber section 102 that passes through an optical feed through 104 into a chamber 106 defined by a metal housing 108 that is formed, for example, from titanium. Hydrostatic pressure applied to the metal housing 108 is transferred to a glass tube 110 that is disposed within the chamber 106. In the embodiment shown, the inside 112 of the glass tube 110 is filled with a metal (e.g., gallium or a gallium alloy) that is in liquid form in the intended operating environment. The inside 112 of the glass tube 110 is also vented to the chamber 106 of the metal tube 108 through a breather capillary 114 to thereby provide for pressure transfer between the chamber 106 of the metal housing 108 and the inside 112 of the glass tube 110. In this construction, the inside 112 of the glass tube 110 forms a pressure chamber operably coupled to the chamber 106 of the metal housing 108, and the metal housing 108 protects the components therein from the environment outside the housing 108. As such, the sensor 100 is suitable for harsh environments, such as downhole monitoring in oil and gas drilling and production applications. The optical fiber section 102 extends into the inside 112 of the glass tube 110 where it is coupled to a sequence of optical processing elements, including a fiber grating 116, an in-line polarizer 118, a section of side-hole fiber or polarization-maintaining crystal fiber 120, and a fiber mirror 122, disposed inside the glass tube 110. Exemplary embodiments of the sensor unit 100 are further described in U.S. Pat. No. 7,684,656.

In some embodiments, the sensor unit 100 may also include a bellows structure (not shown) that is disposed at the end of the metal housing 108 opposite the feed through 104. In such embodiments, the bellows structure provides for longitudinal deformation of the housing 108 in response to hydrostatic pressures applied to the sensor unit 110. Such longitudinal deformation varies the volume of the chamber 106, thereby transferring the environmental pressure changes to the glass tube 110.

As described, in some embodiments the first completion component system component 40 may be a control line made from an inconel alloy, a monel alloy or stainless steel, and the second completion system component 42 may be a sensor or sensor assembly, made at least in part of titanium or a titanium alloy. Typically, titanium and stainless steel and/or titanium and inconel/monel are considered dissimilar materials in that they may not be readily connected to each other through a conventional welding operation such as orbital welding, MIG welding, or TIG welding. In such embodiments, the first completion system component 40 may be joined to an adaptor 41, and the second completion system component 42 may also be joined to the adaptor 41. The portion of the adaptor 42 which connects to the first completion system component 40 may be made of or compatible with the material (e.g. inconel, monel, or stainless steel, and alloys thereof) at the connection portion of the first completion system component 40, and the portion of the adaptor 41 which connects to the second completion system component 42 may be made of or compatible with the material (e.g. titanium or titanium alloys) at the connecting portion of the second completion system component 42. As the metals at the interfaces between the adaptor 41 and first/second completion system components 40, 42 are similar or compatible; the adaptor may be joined to either completion system component through a conventional metal joining process, for example, through welding (e.g. orbital TIG, MIG, TIG, etc).

Referring generally to FIG. 4, a schematic view of an embodiment with a joined connection between a first completion system component 40, an adaptor 41, and a second completion system component 42 is shown. The adaptor 41, has a first section 41a, made of a material similar or compatible to that of the first completion system component 40, which allows for a non-mechanical type connection 43 (e.g. weld) between the adaptor 41 and the first completion system component 40. Likewise, the adaptor 41, has a second section 41b, made of a material similar or compatible to that of the second completion system component 42, which allows for a non-mechanical type connection 44 (e.g. weld) between the adaptor 41 and the second completion system component 42. While the entire first and second completion system components 40, 42 may not be made entirely of the given material(s), at least those portions which will connect to the adaptor 41 are. A communication pathway 47 runs through the adaptor 41, and at least portions of the first and second completion system components 40, 42 to allow communication through the adaptor 41 and between the components 40, 42. It should be understood that this embodiment is schematic in nature, and the various lengths and relative dimensions of the adaptor 41, and first and second completion system components 40, 42 may vary.

In some embodiments, adaptor 41 may be made though an explosive bonding process. Explosive bonding, or explosive welding, is a joining process that involves the use of explosives to accelerate metals into each other with sufficient velocity and in a proper orientation to each other, to allow a metallurgical joint to be created. Exemplary embodiments of explosion bonding methods are described in U.S. Pat. Nos. 7,832,614, and 7,530,485.

In embodiments where adaptor 41 is made through an explosive bonding process, a piece of material, for instance a sheet of metal made of a first material (e.g. inconel, stainless steel, or alloys thereof) is explosively bonded with a piece of material, for instance a sheet of metal made of a second material (e.g. titanium or titanium alloys). Adaptor 41 then may be machined out of the resulting explosively bonded sheets, to result in an adaptor 41 with a first section 41a made of the first material, and a second section 41b made of the second material. Adaptor 41 may be machined using conventional machining techniques. The bond 46 between the two sections 41a, 41b made of different materials forms such that there is a complete joining between these two sections 41a, 41b (e.g. a full weld).

In some embodiments, an interlayer of a third material (not shown) may be disposed between the first section 41a and the second section 41b. This interlayer serves to optimize or enhance the explosive bonding process, and its presence is determined in part by the selection of the materials to be used for the first and second sections 41a, 41b, prior to the explosive bonding process. In some embodiments, the interlayer may be made of niobium, niobium alloys, silver, silver alloys or titanium (when titanium is not one of the materials to be used for the first and second sections 41a, 41b).

While a limited number of embodiments been described, those skilled in the art, having the benefit of this disclosure, will appreciate numerous modifications and variations there from. It is intended that the appended claims cover all such modifications and variations.

What is claimed is:

1. A completion system for use in a well, comprising:
a first completion system component made at least partly of a first material;
a second completion system component made at least partly of a second material, the second material being dissimilar from the first material; and
an adaptor to connect the first completion component and the second completion component, wherein the adaptor comprises a first adaptor portion made of or compatible with the first material and a second adaptor portion made of or compatible with the second material, and wherein the connections between both the adaptor and the first completion system component and the connection between the adaptor and the second completion system component are not a mechanical type connections.

2. The completion system of claim 1, wherein the connections between the adaptor and the first and second completion system components are welded connections.

3. The completion system of claim 1, wherein the first adaptor portion and the second adaptor portion are joined together through a bond formed through explosive bonding.

4. The completion system of claim 3, further comprising an interlayer disposed between the first adaptor portion and the second adaptor portion, wherein the interlayer is made of a third material which is dissimilar to both the first and the second materials, and wherein the interlayer facilitates the bonding of the first adaptor portion to the second adaptor portion.

5. The completion system of claim 4, wherein the interlayer is made of niobium or a niobium alloy.

6. The completion system of claim 1, further comprising a communication pathway through the adaptor, allowing communication between the first completion system component and the second completion system component.

7. The completion system of claim 6, wherein the communication pathway comprises at least one member selected from the group consisting of: a fluid communication pathway, an electrical conductor, and a fiber optic.

8. The completion system of claim 1, wherein one of the first or second materials is stainless steel or a stainless steel alloy.

9. The completion system of claim 1, wherein one of the first or second materials is titanium or a titanium alloy.

10. The completion system of claim 1, wherein one of the first or second materials is inconel or an inconel alloy.

11. The completion system of claim 1, wherein the first completion system component comprises a sensor and the second completion system component comprises a control line.

12. A method for providing a connection between two downhole components, comprising:
providing a first completion system component, wherein the first completion system component is made at least partly of a first material;
providing a second completion system component, wherein the second completion system component is made at least partly of a second material which is dissimilar to the first material;
providing an adaptor, wherein the adaptor comprises a first adaptor portion at least partly made of or compatible with the first material and a second adaptor portion at least partly made of or compatible with the second material, and wherein the first adaptor portion and the second adaptor portion are joined together by a bond formed through an explosive bonding operation;
connecting the first completion system component to the first adaptor portion;
connecting the second completion system component to the second adaptor portion; and
deploying the combined adaptor and first and second completion system components into downhole well system.

13. The method of claim 12, further comprising connecting the first and second completion system components to the respective first and second adaptor portions through welding.

14. The method of claim 12, wherein the first completion system component comprises a sensor and the second completion system component comprises a control line.

15. The method of claim 12, transmitting signals through the adaptor, between the first completion system component and the second completion system component, wherein the adaptor comprises a communication pathway to allow the passage of the signals.

16. The method of claim 15, wherein the communication pathway comprises at least one member selected from the group consisting of: a fluid communication pathway, an electrical conductor, and a fiber optic.

17. The method of claim 12, wherein one of the first or second materials is stainless steel or a stainless steel alloy.

18. The method of claim 12, wherein one of the first or second materials is titanium or a titanium alloy.

19. The method of claim 12, wherein one of the first or second materials is inconel or an inconel alloy.

20. The method of claim 12, wherein the adaptor further comprises an interlayer made of niobium or niobium alloy which is disposed at least partly between the first adaptor portion and the second adapter portion, and which enhances or optimizes the bonding action formed through the explosive bonding operation.
